(19) United States
(12) Patent Application Publication
(10) Pub. No.: US 2022/0011931 A1
(43) Pub. Date: Jan. 13, 2022

(54) INFORMATION DISPLAY INTERACTION METHOD AND APPARATUS, COMPUTER DEVICE AND MEDIUM

(71) Applicant: BOE Technology Group Co., Ltd., Beijing (CN)

(72) Inventors: Pengpeng Feng, Beijing (CN); Jiashuang Zong, Beijing (CN); Meichao Li, Beijing (CN)

(73) Assignee: BOE Technology Group Co., Ltd., Beijing (CN)

(21) Appl. No.: 17/297,542

(22) PCT Filed: Aug. 11, 2020
(86) PCT No.: PCT/CN2020/108319

§ 371 Date: May 27, 2021

(30) Foreign Application Priority Data
Aug. 14, 2019 (CN) 201910749377.X

(51) Int. Cl. G06F 3/0484; G06F 3/0488; G06F 3/0481

(52) U.S. Cl. CPC G06F 3/04847; G06F 3/04883; G06F 2203/04104; G06F 3/04812; G06F 3/04817

(57) ABSTRACT

A method and device of displaying and interaction of information, a computer device and a medium. The method includes: displaying a frame on a touch-controlled screen having a plurality of interaction regions, wherein the frame includes a plurality of identifiers, a displaying position of each identifier of the plurality of identifiers on the touch-controlled screen changes over time, to form a displaying trajectory of the identifier, and the displaying trajectory of the identifier is distributed in the plurality of interaction regions; and under the condition that the displaying position of the identifier has entered any one interaction region of the plurality of interaction regions, in response to a touch-controlling operation to the identifier, presenting the exhibited information of the identifier on the touch-controlled screen.

The present application claims the priority of the Chinese patent application filed on Aug. 14, 2019 with the application number of 201910749377.X, which is incorporated herein in its entirety by reference.

### TECHNICAL FIELD

The present disclosure relates to the technical field of displaying, and more particularly relates to a method and device of displaying and interaction of information, a computer device and a medium.

### BACKGROUND

Currently, in sites such as banks, exhibitions, product launches, museums and shopping malls, usually a displaying screen is provided that is used to exhibit products or service and introduce and promote the products or service. However, conventional displaying screens of this type generally have the problems of monotonous exhibited contents and dull functions, have difficulty in attracting the attention of users, and have a poor effect of the promotion of products or service.

Therefore, it is needed to provide new method and device of displaying and interaction of information, a computer device and a medium.

### SUMMARY

The purpose of the present disclosure is to provide a method and device of displaying and interaction of information, a computer device and a medium.

An aspect of the present disclosure provides a method of displaying and interaction of information, comprising: displaying a frame on a touch-controlled screen having a plurality of interaction regions, wherein the frame comprises a plurality of identifiers, a displaying position of each identifier of the plurality of identifiers on the touch-controlled screen changes over time, to form a displaying trajectory of the identifier, and the displaying trajectory of the identifier is distributed in the plurality of interaction regions; and under the condition that the displaying position of the identifier has entered any one interaction region of the plurality of interaction regions, in response to a touch-controlling operation to the identifier, presenting exhibited information of the any one identifier on the touch-controlled screen.

Optionally, before the step of, in response to the touch-controlling operation to the identifier, presenting the exhibited information of the any one identifier on the touch-controlled screen, the method further comprises: detecting whether an interaction mode of the touch-controlled screen is a single-person interaction mode or a multi-person interaction mode; and the step of, in response to the touch-controlling operation to the identifier, presenting the exhibited information of the any one identifier on the touch-controlled screen comprises: under the condition that it is detected that the interaction mode of the touch-controlled screen is the single-person interaction mode, in response to a touch-controlling operation to the identifier in the any one interaction region, presenting the exhibited information of the identifier on the touch-controlled screen in full screen; and under the condition that it is detected that the interaction mode of the touch-controlled screen is the multi-person interaction mode, in response to a touch-controlling operation to the identifier in the any one interaction region, presenting the exhibited information of the identifier on the any one interaction region.

Optionally, the step of detecting whether the interaction mode of the touch-controlled screen is a single-person interaction mode or a multi-person interaction mode comprises: collecting scene images in front of the interaction regions and performing image recognition, to acquire quantities of users in front of each of the interaction regions; under the condition that a sum of the quantities of the users in front of each of the interaction regions is equal to 1, determining that the interaction mode of the touch-controlled screen is the single-person interaction mode; and under the condition that a sum of the quantities of the users in front of each of the interaction regions is greater than 1, determining that the interaction mode of the touch-controlled screen is the multi-person interaction mode.

Optionally, the identifier comprises a graphic identifier and/or a text mark.

Optionally, the respective displaying trajectories of the plurality of identifiers are a plurality of orbit trajectories that revolve around a predetermined center point; and a size of each identifier of the plurality of identifiers changes with a frequency of touch-controlling operations to the identifier.

Optionally, the respective displaying trajectories of the plurality of identifiers are a plurality of orbit trajectories that revolve around a predetermined center point; and a size of the displaying trajectory of each identifier of the plurality of identifiers changes with a frequency of touch-controlling operations to the identifier.

Optionally, the changing of the size of the identifier with the frequency of the touch-controlling operations to the identifier comprises: increasing the size of the identifier with increasing of the frequency of the touch-controlling operations to the identifier; or the changing of the size of the displaying trajectory of the identifier with the frequency of the touch-controlling operations to the identifier comprises: increasing a radius of the displaying trajectory of the identifier with increasing of the frequency of the touch-controlling operations to the identifier.

Optionally, the exhibited information of the identifier comprises: at least one of text information, image information and a sub-identifier of the identifier.

Optionally, the step of, in response to the touch-controlling operation to the identifier in the any one interaction region, presenting the exhibited information of the identifier on the any one interaction region comprises: in response to the touch-controlling operation to the identifier in the any one interaction region, presenting a plurality of exhibition pages on the any one interaction region, wherein each of the plurality of exhibition pages comprises text information and/or image information in a form of a buoyed layer; and in response to a sliding touch-controlling operation in the any one interaction region, displaying one exhibition page of the plurality of exhibition pages on top and in center.

Optionally, the step of, in response to the touch-controlling operation to the identifier in the any one interaction region, presenting the exhibited information of the identifier on the touch-controlled screen in full screen comprises: in response to the touch-controlling operation to the identifier in the any one interaction region, presenting a sub-identifier list of the identifier in a sub-identifier displaying region of the touch-controlled screen, and presenting, in an information displaying region of the touch-controlled screen, text information and/or image information of a sub-identifier of the sub-identifier list that is currently in a center position, and in response to a sliding touch-controlling operation to the sub-identifier list or a clicking touch-controlling operation to one sub-identifier of the sub-identifier list, changing the sub-identifier of the sub-identifier list that is in the center position; or in response to the touch-controlling operation to the identifier in the any one interaction region, presenting a sub-identifier list corresponding to the identifier in a sub-identifier displaying region of the touch-controlled screen, in response to a sliding touch-controlling operation to the sub-identifier list, changing the sub-identifier of the sub-identifier list that is in the center position, and in response to a clicking touch-controlling operation to the sub-identifier in the center position, presenting an exhibition page that comprises text information and/or image information in a form of a buoyed layer of the sub-identifier.

Optionally, the step of, in response to the touch-controlling operation to the identifier in the any one interaction region, presenting the exhibited information of the identifier on the touch-controlled screen in full screen further comprises: presenting a navigation bar in a navigation displaying region of the touch-controlled screen, wherein the navigation bar comprises at least one of: the other identifiers of the plurality of identifiers, and a returning identifier.

Optionally, the method further comprises: under the condition that the exhibited information of the identifier is being presented on the any one interaction region or presented on the touch-controlled screen in full screen, judging whether a touch-controlling operation to the exhibited information is received within a preset duration threshold, and if no, stopping presenting the exhibited information of the identifier.

According to another aspect of the present disclosure, there is provided a device of displaying and interaction of information, wherein the device comprises a controller and a touch-controlled screen; the touch-controlled screen has a plurality of interaction regions; and the controller is configured for implementing the method according to any one of the above items.

Optionally, the touch-controlled screen has three interaction regions that are arranged side by side.

Optionally, the touch-controlled screen is a touch-controlled spliced screen that is formed by splicing a plurality of sub-touch-controlled screens, and each of the interaction regions comprises at least one of the sub-touch-controlled screens.

According to another aspect of the present disclosure, there is provided a computer device, comprising a memory, a processor and a computer program that is stored in the memory and is executable on the processor, wherein the processor, when executing the computer program, implements the method according to any one of the above items.

According to another aspect of the present disclosure, there is provided a computer-readable storage medium, storing a computer program, wherein the computer program, when being executed by a processor, implements the method according to any one of the above items.

The advantageous effects of the present disclosure are as follows:

The technical solutions according to the present disclosure can dynamically perform information exhibition according to the touch-controlling operation to the identifier by the user, which can improve the interaction experience of the user, facilitate to attract the attention of users, and improve the effect of the promotion of products or service. Further, the method can realize the simultaneous interaction of multiple users, which refers to that multiple users perform touch controlling simultaneously in different interaction regions and each of the multiple users is exhibited by using the corresponding interaction region with the exhibited information of the identifier that he is touch-controlling, whereby, when all of multiple users intend to view the information, they are not required to queue up and view sequentially, which increases the efficiency of the information exhibition, and improves the user experience. Furthermore, each of the identifiers can move among the plurality of interaction regions, which can realize that each of the interaction regions is not required to display all of the identifiers.

### BRIEF DESCRIPTION OF THE DRAWINGS

The particular embodiments of the present disclosure will be described in further detail below with reference to the drawings.

FIG. 1 shows a flow chart of the method of displaying and interaction of information according to an embodiment of the present disclosure.

FIG. 2A shows a schematic diagram of a main interface.

FIG. 2B shows an illustrative flow chart of the method of displaying and interaction of information according to another embodiment of the present disclosure.

FIG. 3 shows a schematic diagram of an information presenting interface presented in full screen in the single-person interaction mode.

FIG. 4 shows a schematic diagram of another information presenting interface presented in full screen in the single-person interaction mode.

FIG. 5 shows a schematic diagram of an information presenting interface after the sub-identifier “bank card” in the information presenting interface shown in FIG. 4 has been clicked on.

FIG. 6 shows, when, in the multi-person interaction mode, a user is touch-controlling an identifier that has moved to an interaction region in the middle, a schematic diagram of an information presenting interface in the interaction region.

FIG. 7 shows, when, in the multi-person interaction mode, a user is touch-controlling an identifier that has moved to an interaction region in the middle and another user is touch-controlling an identifier that has moved to an interaction region on the right, a schematic diagram of the information presenting interfaces of the two interaction regions.

FIG. 8 shows a flow chart of a method of displaying and interaction of information using user quantity determination.

FIG. 9 shows an illustrative structural diagram of the device of displaying and interaction of information according to another embodiment of the present disclosure.

FIG. 10 shows a schematic structural diagram of the device of displaying and interaction of information according to an embodiment of the present disclosure.

### DETAILED DESCRIPTION

In order to more clearly illustrate the present disclosure, the present disclosure will be further described below with reference to the preferable embodiments and the drawings. The similar components in the drawings are indicated by the same reference numbers. A person skilled in the art should understand that the contents described particularly below are illustrative, rather than limiting, and should not be used to limit the protection scope of the present disclosure.

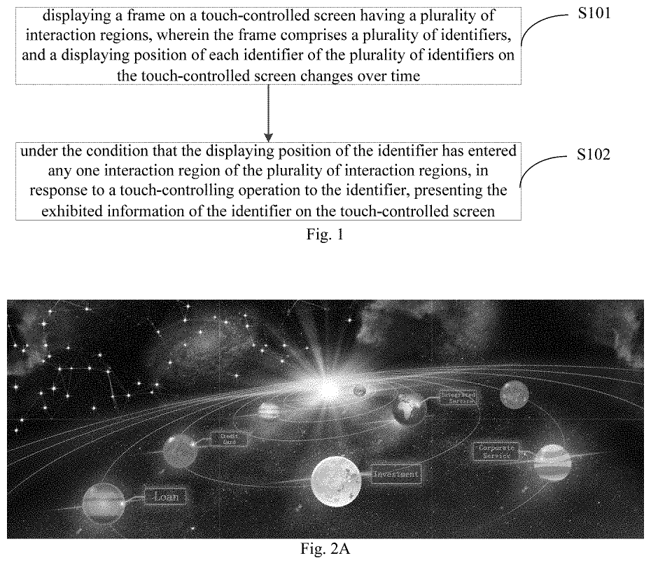

As shown in FIG. 1, an embodiment of the present disclosure provides a method of displaying and interaction of information, which may comprise: steps S101-S102.

Step S101: displaying a frame on a touch-controlled screen having a plurality of interaction regions, wherein the frame comprises a plurality of identifiers, and a displaying position of each identifier of the plurality of identifiers on the touch-controlled screen changes over time.

Exemplarily, regarding each identifier of the plurality of identifiers, the variation of the displaying position of the identifier on the touch-controlled screen forms the displaying trajectory of the identifier, and the displaying trajectory of the identifier is distributed in the plurality of interaction regions; in other words, the identifier can be displayed in different interaction regions at different moments. Regarding the displaying effect, each of the plurality of identifiers can perform periodic movement among the plurality of interaction regions, and, depending on the shape of the displaying trajectory of an identifier, the periodic movement of the identifier may be, for example, a reciprocating movement, a circular movement, an elliptical movement and so on.

Step S102: under the condition that the displaying position of the identifier has entered any one interaction region of the plurality of interaction regions, in response to a touch-controlling operation to the identifier, presenting the exhibited information of the identifier on the touch-controlled screen.

It can be understood that the step S102 is applicable to each identifier of the plurality of identifiers. At the same moment, when different identifiers are being displayed in different interaction regions, the step S102 may be executed on the different identifiers.

The method of displaying and interaction of information according to the embodiments of the present disclosure can dynamically perform information exhibition according to the touch-controlling operation to the identifier (for example, a clicking on the identifier) by the user, which can improve the interaction experience of the user, facilitate to attract the attention of users, and improve the effect of the promotion of products or service. Further, because the touch-controlled screen comprises a plurality of interaction regions, the method can realize the simultaneous interaction of multiple users, which refers to that multiple users can perform touch controlling simultaneously in different interaction regions to different identifiers displayed in the interaction regions and the touch-controlled screen can exhibit to each of the multiple users by using the corresponding interaction region the exhibited information of the identifier that he is touch-controlling, whereby, when all of multiple users intend to view the information, they are not required to queue up and view sequentially, which increases the efficiency of the information exhibition, and improves the user experience. Furthermore, the displaying trajectories of the identifiers may be distributed in the plurality of interaction regions, whereby each of the identifiers may be displayed in different interaction regions at different moments, and different identifiers may be displayed in different interaction regions at the same moment, which can realize the technical effect that each of the interaction regions is not required to display all of the identifiers.

In the plurality of identifiers that can periodically move among the plurality of interaction regions that the frame comprises, one identifier represents the item, classification name or catalogue title of one type of information. In addition, one mode of the plurality of identifiers periodically moving among the plurality of interaction regions is that each of the identifiers performs periodic movement individually, and each of the identifiers sequentially moves to all of the interaction regions within one movement period (from the point of view of the displayed frame, that may be described as sequentially appearing in each of the interaction regions). On the basis of that, each of the identifiers may respond to a touch-controlling operation at any one position of the displaying trajectory of the identifier, and the next displaying position of the identifier may be controlled to be the any one position, thereby presenting to the user the displaying effect in which the identifier quickly moves (or, in other words, is dragged to) the interaction region where the any one position is located. For example, the frame further comprises the movement trajectory line (i.e., the displaying trajectory according to the above embodiments) of each of the identifiers, and when an identifier is being displayed in one interaction region, in response to a sliding or clicking touch-controlling operation to the movement trajectory line of the identifier presented in another interaction region, the identifier is controlled to quickly move to the another interaction region. Such a mode can, when multiple users are simultaneously performing touch-controlling in different interaction regions, prevent that a user is required to wait for a long time before the identifier of the information that he intends to view has moved to the interaction regions in front of him, which may further improve the user experience.

In a particular embodiment, the method of displaying and interaction of information according to an embodiment of the present disclosure may be used for a bank branch to exhibit the financial services to the clients. The touch-controlled screen is provided in the hall of the bank branch. The identifiers represent the items, classification names or catalogue titles of various types of financial services; for example, one identifier represents the items of investment, another identifier represents the items of corporate service, yet another identifier represents the items of loan, still another identifier represents the items of credit card, and so on. The exhibited information of the identifiers is the concrete introduction of the corresponding types of the financial services.

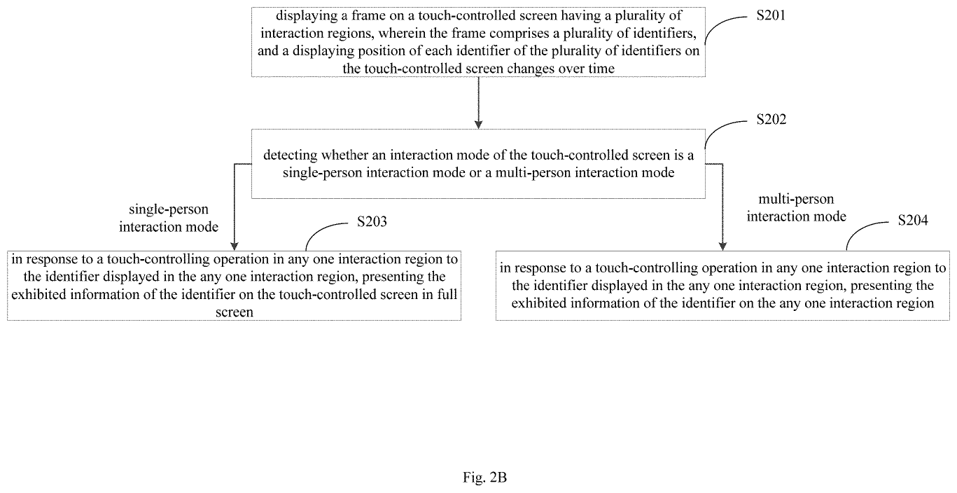

Exemplarily, before the step of, in response to a touch-controlling operation to the identifier displayed in the any one interaction region, presenting the exhibited information of the identifier on the touch-controlled screen, i.e., in the initial state in which the user has not performed a touch-controlling operation, the touch-controlled screen displays in full screen a frame comprising the plurality of identifiers, and the interaction interface of the frame may be referred to as a main interface. Continuing with the above particular embodiments, the main interface is shown in FIG. 2A.

Continuing with the above particular embodiments, a static displaying region may be provided at a position in the main interface shown in FIG. 2A, such as the top right corner of the main interface, wherein the static displaying region displays contents such as a welcome banner, weather information and bank-interest-rate information.

In some alternative implementations of an embodiment of the present disclosure, before the step of, in response to a touch-controlling operation to the identifier displayed in the any one interaction region, presenting the exhibited information of the identifier on the touch-controlled screen, the method further comprises: detecting whether an interaction mode of the touch-controlled screen is a single-person interaction mode or a multi-person interaction mode.

FIG. 2B shows an illustrative flow chart of the method of displaying and interaction of information according to another embodiment of the present disclosure.

As shown in FIG. 2B, the method may comprise steps S201-S204. The implementation of the step S201 is similar to that of the step S101 in the above embodiment, and is not discussed here further.

Step S202: detecting whether an interaction mode of the touch-controlled screen is a single-person interaction mode or a multi-person interaction mode; under the condition that it is detected that the interaction mode of the touch-controlled screen is the single-person interaction mode, executing the step S203; and under the condition that it is detected that the interaction mode of the touch-controlled screen is the multi-person interaction mode, executing the step S204.

Step S203: under the condition that it is the single-person interaction mode, in response to a touch-controlling operation in any one interaction region to the identifier displayed in the any one interaction region, presenting the exhibited information of the identifier on the touch-controlled screen in full screen.

Step S204: under the condition that it is the multi-person interaction mode, in response to a touch-controlling operation in any one interaction region to the identifier displayed in the any one interaction region, presenting the exhibited information of the identifier on the any one interaction region.

By using such an implementation, the touch-controlled screen can employ the two interaction modes, wherein, in the single-person interaction mode, it can exhibit to the user, by using the maximized displaying size, the exhibited information of the identifier that he is clicking on. In the multi-person interaction mode, it can exhibit, by using the different interaction regions, the exhibited information of a plurality of identifiers that are touch-controlling operated, to enable the multiple users to use together.

In some alternative implementations of an embodiment of the present disclosure, the method of displaying and interaction of information may further comprise: in the single-person interaction mode, when the exhibited information of an identifier is being presented on the touch-controlled screen in full screen, presenting a returning identifier on the touch-controlled screen, in response to a touch-controlling operation to the returning identifier (for example, an operation of clicking on the returning identifier), displaying the frame on the touch-controlled screen having the plurality of interaction regions, i.e., stopping presenting the exhibited information of the identifier, and returning to the state that the touch-controlled screen displays the main interface in full screen.

In the multi-person interaction mode, the method comprises, when the exhibited information of an identifier is being presented on one of the interaction regions, presenting a returning identifier on the interaction region, and in response to a touch-controlling operation to the returning identifier (for example, an operation of clicking on the returning identifier), presenting the main interface on the touch-controlled screen, i.e., stopping presenting the exhibited information corresponding to the identifier on the interaction region, to cause the touch-controlled screen to return to the state of displaying the main interface.

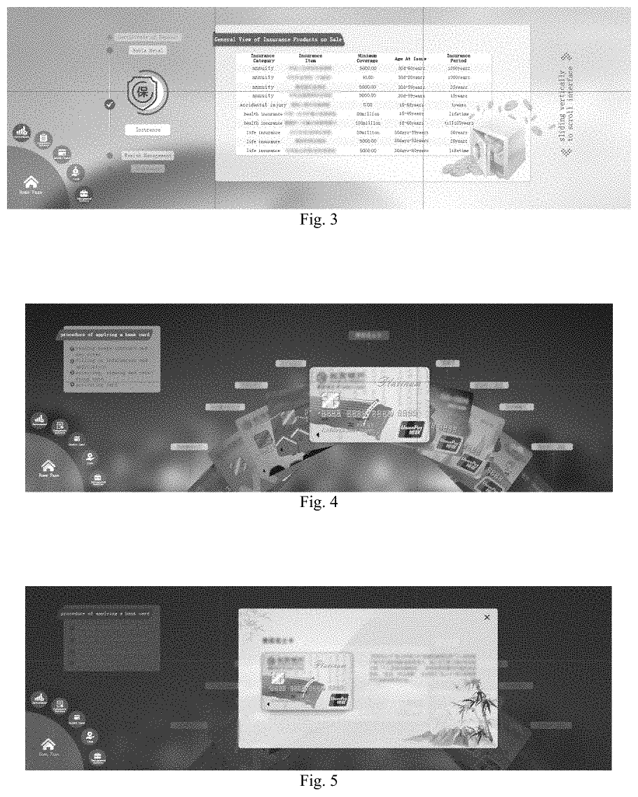

Continuing with the above particular embodiments, the returning identifier presented in the single-person interaction mode is, for example, an icon labeling “home page” shown at the bottom left corner of FIGS. 3-5.

In some alternative implementations of an embodiment of the present disclosure, the method of displaying and interaction of information may further comprise: under the condition that the exhibited information of the identifier is being presented on the any one interaction region or presented on the touch-controlled screen in full screen, judging whether a touch-controlling operation to the exhibited information is received within a preset duration threshold, and if no, which indicates that the duration of no touch-controlling operation in the interaction region or the full screen of the touch-controlled screen is greater than a preset duration threshold, and the user might not require the exhibited information of the identifier any longer for further operations, stopping presenting the exhibited information of the identifier.

By using such an implementation, the present embodiment can, by using the preset duration threshold of no touch-controlling operation, enable the interaction region in the multi-person interaction mode or the full screen of the touch-controlled screen in the single-person interaction mode to automatically stop presenting the exhibited information of the identifier (i.e., causing the part corresponding to the interaction region or the touch-controlled screen as a whole to return the state of displaying the main interface), which can further improve the interaction experience of the user. In a particular embodiment, the preset duration threshold may be set to be 2 minutes or 3 minutes.

In some alternative implementations of an embodiment of the present disclosure, the step S202 of detecting whether an interaction mode of the touch-controlled screen is a single-person interaction mode or a multi-person interaction mode may be executed in the following manner:

collecting scene images in front of the interaction regions and performing image recognition, to acquire quantities of users in front of each of the interaction regions; under the condition that a sum of the quantities of the users in front of each of the interaction regions is equal to 1, setting the touch-controlled screen to be in the single-person interaction mode; and under the condition that a sum of the quantities of the users in front of each of the interaction regions is greater than 1, setting the touch-controlled screen to be in the multi-person interaction mode.

By using such an implementation, the present embodiment can realize self-adaptively setting the interaction mode according to the quantity of the users in front of the touch-controlled screen, which can further improve the interaction experience of the user. It should be noted that the switching between the interaction modes should be performed when the touch-controlled screen is displaying a frame comprising a plurality of identifiers that can periodically move among a plurality of interaction regions (i.e., when displaying the main interface), to prevent changing the size of the information presenting interface when the user is viewing the information and thus affecting the interaction experience of the user. Continuing with the above particular embodiments, the setting of the interaction mode may also be based on the controlling by a bank personnel and so on, and the implementation is merely a preferable embodiment of automatic setting. Further, when the sum of the quantities of the users is 1, or, in other words, merely one client is in front of the touch-controlled screen, the interaction mode may also be set to be the multi-person interaction mode, to enable the client to use the plurality of interaction regions to simultaneously acquire multiple types of information on banking businesses.

In some alternative implementations of an embodiment of the present disclosure, the identifier comprises a graphic identifier and/or a text mark.

By using such an implementation, the interaction experience of the user can be further improved based on a high-interactivity graphic identifier and/or a clear text mark, which further facilitates to attract the attention of users, and can further improve the effect of the promotion of products or service. In the mode in which the identifier comprises a graphic identifier and a text mark, the mode of determining the touch-controlling operation to the identifier may be determining merely the touch-controlling operation to the graphic identifier exerted by the user as a touch-controlling operation to the identifier, and may also be determining the touch-controlling operation to the graphic identifier or the text mark exerted by the user as a touch-controlling operation to the identifier. For example, continuing with the above particular embodiments, when the client has clicked on the text mark “credit card” shown in FIG. 2A, or the graphic identifier in the shape of a star corresponding to the text mark, the introduction information of the credit-card service is presented in both of the cases. It should be noted that, when the identifier is being moved, its graphic identifier and text mark are moved synchronously, and their relative position is constant.

In some alternative implementations of an embodiment of the present disclosure, the respective displaying trajectories of the plurality of identifiers are a plurality of orbit trajectories that revolve around a predetermined center point, whereby the frame displayed by the touch-controlled screen comprises a plurality of identifiers that can revolve around a predetermined center point in orbits that have different distances to the predetermined center point. The sizes of the identifiers and/or the sizes of the orbit trajectories of the movements may change with the frequency of the touch-controlling operations to the corresponding identifiers.

By using such an implementation, the interaction experience of the user can be further improved by using an exhibition mode that simulates the solar system or a similar galaxy in which planets revolve around a sun, which further facilitates to attract the attention of users, and can further improve the effect of the promotion of products or service. Furthermore, the sizes of the identifiers and/or the orbits of the movements of the identifiers may be self-adaptively set according to the attention levels of users, and the identifiers of high attention levels may be specifically highlighted.

In some alternative implementations of an embodiment of the present disclosure, that the sizes of the identifiers and/or the sizes of the orbit trajectories of the movements change with the frequency of the touch-controlling operations to the corresponding identifiers may be executed in the following manner: taking any one identifier of the plurality of identifiers as an example, the size of the identifier is increased with the increasing of the frequency of the touch-controlling operations to the identifier; and/or, in the case in which the orbit trajectory is a circle, the radius of the orbit trajectory of the identifier is increased with the increasing of the frequency of the touch-controlling operations to the identifier; and/or, in the case in which the orbit trajectory is an ellipse, at least one of the major axis and the minor axis of the orbit trajectory of the identifier is increased with the increasing of the frequency of the touch-controlling operations to the identifier.

By using such an implementation, the present embodiment can, according to the attention levels of users, increase the size of the identifier of a high attention level and/or increase the radius of the orbit of the movement of the identifier of a high attention level, to specifically highlight the identifiers of high attention levels.

Continuing with the above particular embodiments, as shown in FIG. 2A, the graphic identifier in the identifier is a graphic identifier of a pattern of a planet, and the frame comprises a plurality of identifiers that revolve around a predetermined center point in orbits that have different distances to the predetermined center point refers to that: the frame comprises a plurality of graphic identifiers of a pattern of a planet that individually revolve around a static identifier of a pattern of a sun, wherein each of the graphic identifiers of a pattern of a planet passes through all of the interaction regions in the revolution via a complete circle. The frame (the main interface) in such a form may be referred to as a galaxy guiding interface. In the galaxy guiding interface, in order for an exhibition mode that simulates that the planets revolve around the sun in the solar system, the graphic identifier of a pattern of a planet uses the static identifier of a pattern of the sun as the predetermined center point, and the planets revolve following the elliptical orbits having different distances to the predetermined center point. Furthermore, nebula and so on may be interspersed in the galaxy guiding interface, to improve the aesthetic degree of the interface.

Continuing with the above particular embodiments, as shown in FIG. 2A, the identifier comprises a graphic identifier and a text mark. In order for an exhibition mode that simulates that the planets revolve around the sun in the solar system, the size of the graphic identifier and/or the orbit trajectory of the movement may not be changed, but instead the correspondence between the text marks and the planets may be directly set according to the attention levels of the clients, to realize the correspondence between the attention levels of the clients and the size of the graphic identifiers of a pattern of a planet and/or the orbit trajectories of the movement. For example, when the attention level of the “credit card” has become higher, the graphic identifier “Jupiter” having a larger size is corresponded to the “credit card”. Moreover, the attention levels of the clients of the identifiers may also be defined by comprehensively taking into consideration the data such as the frequencies of the touch-controlling operations to the identifiers, the time points of the touch-controlling operations to the identifiers and the durations of the touch-controlling operations to the identifiers (i.e., the durations for which the clients are viewing the exhibited information of the identifiers), thereby more accurately realizing the correspondence between the attention levels of the clients and the size of the graphic identifiers of a pattern of a planet and/or the orbit trajectories of the movement. Further, a data sheet may be generated according to the above data, for the bank personnel to referring to in decision-making.

Besides the size of the graphic identifier of a pattern of a planet and/or the orbit trajectory of the movement, the speeds of the revolutions of the graphic identifiers of a pattern of a planet may be individually optimized and set, to ensure the interaction experience of the user. The effect of highlighting the identifier of a higher attention level may also be assisted by defining the upper-and-lower-layer displaying sequence of the graphic identifiers of a pattern of a planet in intersection, for example, setting that, when intersecting happens, the identifier of the higher attention level is displayed at the upper layer and is not blocked.

In some alternative implementations of an embodiment of the present disclosure, the exhibited information of the identifier comprises at least one of text information, image information and a sub-identifier of the identifier.

By using such an implementation, the present embodiment can enable the information exhibition to be more diversified, to improve the richness of the information, which can further improve the interaction experience of the user. In a particular embodiment, the present embodiment can, by providing in the exhibited information of the identifier a plurality of sub-identifiers that correspond to different pieces of classified information, improve the readability of the text information corresponding to the identifier. The sub-identifiers may be further provided with their sub-identifiers, to realize hierarchical identification.

In some alternative implementations of an embodiment of the present disclosure, the step S204 of in response to a touch-controlling operation in any one interaction region to the identifier displayed in the any one interaction region, presenting the exhibited information of the identifier on the any one interaction region may comprise: in response to a touch-controlling operation in any one interaction region to the identifier displayed in the any one interaction region, presenting a plurality of exhibition pages on the any one interaction region, wherein each exhibition page of the plurality of exhibition pages may comprise text information and/or image information in the form of a buoyed layer; and in response to a sliding touch-controlling operation in the any one interaction region, displaying one exhibition page of the plurality of exhibition pages on top and in center.

By using such an implementation, the present embodiment can dynamically exhibit rich information to the users by using the corresponding interaction regions in the multi-person interaction mode, which can further improve the interaction experience of the user.

In some alternative implementations of an embodiment of the present disclosure, the step S203 of in response to a touch-controlling operation in any one interaction region to the identifier displayed in the any one interaction region, presenting the exhibited information of the identifier on the touch-controlled screen in full screen may comprise: in response to a touch-controlling operation in any one interaction region to the identifier displayed in the any one interaction region, presenting a sub-identifier list corresponding to the identifier in a sub-identifier displaying region of the touch-controlled screen, and presenting, in an information displaying region of the touch-controlled screen, text information and/or image information of a sub-identifier of the sub-identifier list that is currently in a center position; and in response to a sliding touch-controlling operation to the sub-identifier list or a clicking touch-controlling operation to one sub-identifier of the sub-identifier list, changing the sub-identifier of the sub-identifier list that is in the center position.

In another embodiment, the method may comprise, in response to a touch-controlling operation in any one interaction region to the identifier displayed in the any one interaction region, presenting a sub-identifier list corresponding to the identifier in a sub-identifier displaying region of the touch-controlled screen, in response to a sliding touch-controlling operation to the sub-identifier list, changing the sub-identifier of the sub-identifier list that is in the center position, and, in response to a clicking touch-controlling operation to the sub-identifier in the center position, presenting an exhibition page that comprises text information and/or image information in a form of a buoyed layer of the sub-identifier.

By using such an implementation, the present embodiment can dynamically exhibit rich information to the user in the single-person interaction mode, which can further improve the interaction experience of the user.

In some alternative implementations of an embodiment of the present disclosure, the step S203 of in response to a touch-controlling operation in any one interaction region to the identifier displayed in the any one interaction region, presenting the exhibited information of the identifier on the touch-controlled screen in full screen may further comprise: presenting a navigation bar in a navigation displaying region of the touch-controlled screen, wherein the navigation bar may comprise: the other identifiers exhibited by the main interface than the identifier that is exhibited in detail currently, and/or a returning identifier.

By using such an implementation, when the user is viewing the exhibited information of a certain identifier in the single-person interaction mode, he can directly, by a touch-controlling operation (for example, clicking) to the other identifiers and/or the returning identifier in the navigation bar, cause the touch-controlled screen to present in full screen the exhibited information of the other identifiers (i.e., skipping among the pieces of exhibited information of the identifiers) and/or stop presenting the exhibited information of the identifiers on the touch-controlled screen (i.e., causing the touch-controlled screen to return to the state of displaying the frame comprising a plurality of identifiers that can periodically move among the plurality of interaction regions), which can further improve the interaction experience of the user.

In some alternative implementations of an embodiment of the present disclosure, for example, the touch-controlled screen has three interaction regions that are arranged side by side. It can be understood that the quantity of the interaction regions in the touch-controlled screen may be set according to the actual requirements by the service, and is not limited here.

Continuing with the above particular embodiments:

In the single-person interaction mode, after the client has clicked on the graphic identifier of a pattern of a planet corresponding to the “investment” in FIG. 2A, the interface presenting the exhibited information in full screen is shown in FIG. 3. The interface comprises a list comprising sub-identifiers such as “insurance” and “wealth management” that can scroll vertically in response to a sliding touch-controlling operation made by the client. In response to a clicking by the client on the sub-identifier “insurance”, it may be presented in the center position of the sub-identifier list, and the concrete introduction information of the insurance business may be presented in the information displaying region (or, in other words, information exhibition bar) on the right.

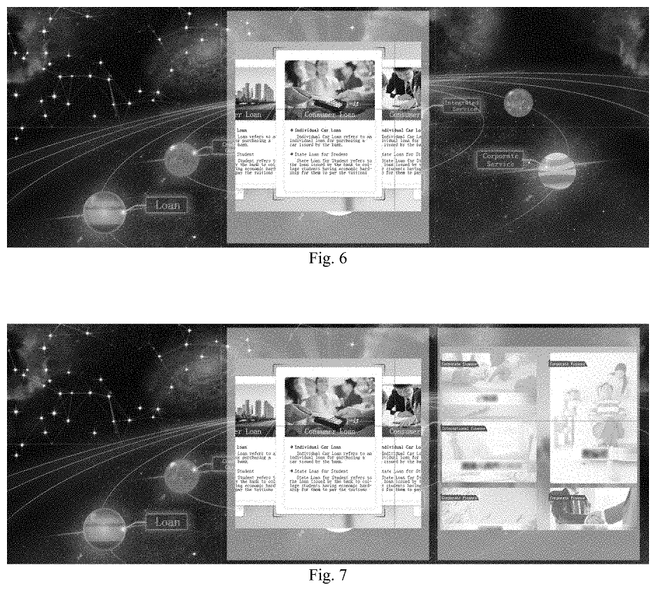

In the single-person interaction mode, after the client has clicked on the graphic identifier of a pattern of a planet corresponding to the “credit card” in FIG. 2A, the interface presenting the exhibited information in full screen is shown in FIG. 4. The interface comprises a list of sub-identifiers corresponding to various types of credit cards with a pattern of a credit card that can move horizontally in response to a sliding touch-controlling operation made by the client. In response to a clicking by the client on the sub-identifier in the center position, the information presenting interface (exhibition page in the form of a buoyed layer) exhibiting the concrete introduction information of the credit card corresponding to the sub-identifier shown in FIG. 5 may be popped up.

In the multi-person interaction mode, for example, when the touch-controlled screen has three interaction regions on the left, in the middle and on the right, when the client A is performing a touch-controlling operation to a certain identifier displayed in the interaction region in the middle, as shown in FIG. 6, the exhibited information of the identifier is presented in the interaction region in the middle, wherein the exhibited information may comprise a plurality of exhibition pages (or, in other words, information introduction pages) that individually comprise text information and image information in the form of a buoyed layer. In response to a horizontal sliding touch-controlling operation made by the client A, one of the introduction pages is displayed on top(placed at the top layer) and in center.

In the multi-person interaction mode, for example, when the touch-controlled screen has three interaction regions on the left, in the middle and on the right, when the client A is performing a touch-controlling operation to a certain identifier displayed in the interaction region in the middle, as shown in FIG. 7, the exhibited information of the identifier is presented in the interaction region in the middle, wherein the exhibited information may comprise a plurality of exhibition pages that individually comprise text information and image information in the form of a buoyed layer. In response to a horizontal sliding touch-controlling operation made by the client A, one of the introduction pages is displayed on top (placed at the top layer) and in center. Simultaneously with that, when the client B is performing a touch-controlling operation to another identifier displayed in the interaction region on the right, as shown in FIG. 7, the exhibited information of the another identifier is presented in the interaction region on the right, wherein the exhibited information may comprise a plurality of exhibition pages that individually comprise text information and image information in the form of a buoyed layer. In response to a clicking by the client B on a certain sub-identifier, the information presenting interface exhibiting the concrete introduction information corresponding to the sub-identifier may be popped up.

In some alternative implementations of an embodiment of the present disclosure, the step of, in response to a touch-controlling operation in any one interaction region to the identifier displayed in the any one interaction region, presenting the exhibited information of the identifier on the touch-controlled screen in full screen further comprises: presenting in a navigation displaying region of the touch-controlled screen a navigation bar comprising the other identifiers and/or a returning identifier.

By using such an implementation, when the user is viewing the exhibited information of a certain identifier in the single-person interaction mode, he can directly, by a touch-controlling operation (for example, clicking) to the other identifiers and/or the returning identifier in the navigation bar, cause the touch-controlled screen to present in full screen the exhibited information of the other identifiers (i.e., skipping among the pieces of exhibited information of the identifiers) and/or stop presenting the exhibited information of the identifiers on the touch-controlled screen (i.e., causing the touch-controlled screen to return to the state of displaying the frame comprising a plurality of identifiers that can periodically move among the plurality of interaction regions), which can further improve the interaction experience of the user.

Continuing with the above particular embodiments, a navigation bar similar to the form of an operating compass displayed in the bottom left corner of the interface shown in FIGS. 3-5 may be employed, to, under the condition that the exhibited information of the identifier is being presented on the touch-controlled screen in full screen, display the other identifiers and the returning identifier on the touch-controlled screen.

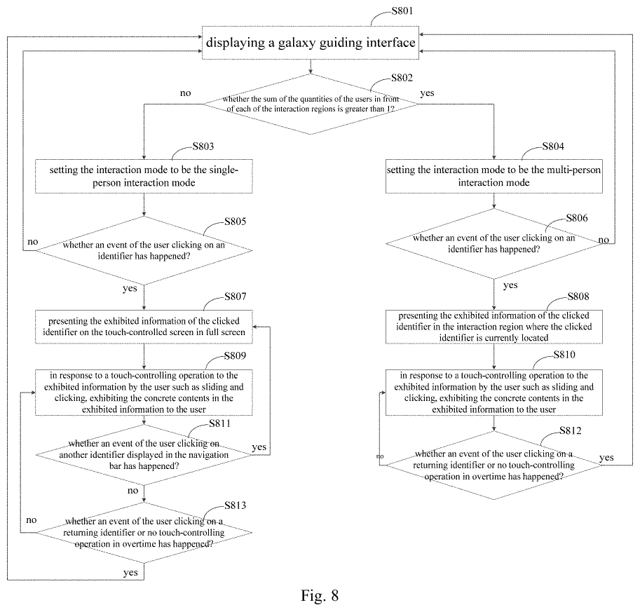

Continuing with the above particular embodiments, a method of displaying and interaction of information that refers to the above implementations is shown in FIG. 8. As an example, the method of displaying and interaction of information may comprise steps S801-S813.

Step S801: displaying a galaxy guiding interface. As one of the main interfaces, the displaying mode and the displayed contents of the galaxy guiding interface have already been described above, and are not discussed here further.

Step S802: collecting scene images in front of the interaction regions and performing image recognition, to acquire quantities of users in front of each of the interaction regions; judging whether the sum of the quantities of the users in front of each of the interaction regions is greater than 1; if no, executing the step S803: setting the interaction mode to be the single-person interaction mode; and if yes, executing the step S804: setting the interaction mode to be the multi-person interaction mode.

After the step S803 and the step S804, the step S805 and the step S806 are individually executed: judging whether an event of the user clicking on an identifier has happened. Regarding the step S805, if the judgement result is yes, the step S807 is executed: presenting the exhibited information of the clicked identifier on the touch-controlled screen in full screen; and if the judgement result is no, the process returns to the step S801. Regarding the step S806, if the judgement result is yes, the step S808 is executed: presenting the exhibited information of the clicked identifier in the interaction region where the clicked identifier is currently located; and if the judgement result is no, the process returns to the step S801.

Step S809 and Step S810: in response to a touch-controlling operation to the exhibited information by the user such as sliding and clicking, exhibiting the concrete contents in the exhibited information to the user. The concrete contents may comprise, for example, at least one of the above text information, image information and information of the sub-identifiers. The exemplary execution of the step S809 and the step S810 has already been described above, and is not discussed here further.

Step S811: judging whether an event of the user clicking on another identifier displayed in the navigation bar has happened; if yes, returning to the step S807; and if no, executing the step S813.

Step S812: judging whether an event of the user clicking on a returning identifier or no touch-controlling operation in overtime has happened; if yes, returning to the step S801; and if no, Returning to the step S810.

Step S813: judging whether an event of the user clicking on a returning identifier or no touch-controlling operation in overtime has happened; if yes, returning to the step S801; and if no, Returning to the step S809.

In some alternative implementations of an embodiment of the present disclosure, the touch-controlled screen is a touch-controlled spliced screen that is formed by splicing a plurality of sub-touch-controlled screens, and each interaction region of the plurality of interaction regions corresponds to at least one of the sub-touch-controlled screens.

By using such an implementation, the present embodiment facilitates to realize a touch-controlled screen of a large size, which can further improve the interaction experience of the user, and is particularly suitable for simultaneous interaction of multiple users in the multi-person interaction mode.

Continuing with the above particular embodiments, as shown in FIGS. 2A and 3-7, the touch-controlled screen is a touch-controlled spliced screen that is formed by splicing six sub-touch-controlled screens, and each of the three interaction regions on the left, in the middle and on the right corresponds to two sub-touch-controlled screens on the top and at the bottom. It should be noted that FIGS. 2A and 3-7 are merely intended to exemplarily illustrate the exhibition modes according to the embodiments of the present disclosure, and the involved concrete service information has been fuzzy-processed, for example, the “ insurance item” in FIG. 3 and the particular names of the credit cards in FIG. 4, which does not affect the exhibition of the solutions of the embodiments of the present disclosure.

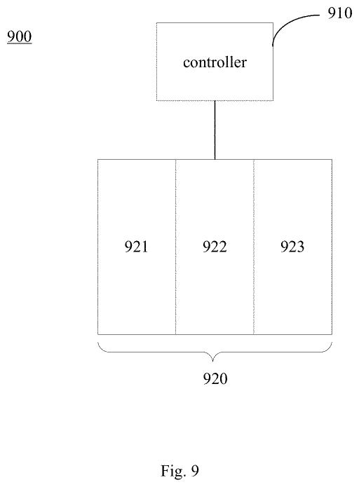

As shown in FIG. 9, another embodiment of the present disclosure provides a device 900 of displaying and interaction of information, which may comprise a controller 910 and a touch-controlled screen 920. Relatively to the user, the controller is located at the rear end, and the touch-controlled screen is located at the front end.

The touch-controlled screen 920 has a plurality of interaction regions 921, 922, 923.

The controller 910 is configured for: controlling the touch-controlled screen to display a frame, wherein the frame comprises a plurality of identifiers, and a displaying position of each identifier of the plurality of identifiers on the touch-controlled screen changes over time, wherein, exemplarily, the frame comprises a plurality of identifiers that can periodically move among the plurality of interaction regions; and in response to touch-controlling operations in different interaction regions to identifiers displayed in the interaction regions, presenting the exhibited information of the identifier on the corresponding interaction region.

The device of displaying and interaction of information according to the embodiments of the present disclosure can dynamically perform information exhibition according to the touch-controlling operation to the identifier (for example, a clicking on the identifier) by the user, which can improve the interaction experience of the user, facilitate to attract the attention of users, and improve the effect of the promotion of products or service. Further, the device can realize the simultaneous interaction of multiple users, which refers to that multiple users perform touch controlling simultaneously in different interaction regions and each of the multiple users is exhibited by using the corresponding interaction region with the exhibited information of the identifier that he is touch-controlling, whereby, when all of multiple users intend to view the information, they are not required to queue up and view sequentially, which increases the efficiency of the information exhibition, and improves the user experience. Furthermore, each of the identifiers can periodically move among the plurality of interaction regions, which can realize that each of the interaction regions is not required to display all of the identifiers.

In some alternative implementations of the present embodiment, the controller is further configured for: detecting whether an interaction mode of the touch-controlled screen is a single-person interaction mode or a multi-person interaction mode; under the condition that it is the single-person interaction mode, in response to a touch-controlling operation in an interaction region to an identifier that has moved to the interaction region, presenting the exhibited information of the identifier on the touch-controlled screen in full screen; and under the condition that it is the multi-person interaction mode, in response to a touch-controlling operation in different interaction regions to an identifier that has moved to the interaction region, presenting the exhibited information of the identifier on the corresponding interaction region.

By using such an implementation, the touch-controlled screen can employ the two interaction modes, wherein, in the single-person interaction mode, it can exhibit to the user, by using the maximized displaying size, the exhibited information of the identifier that he is clicking on.

In some alternative implementations of the present embodiment, the device further comprises an image collector, and the controller is further configured for: performing image recognition to the scene images in front of the interaction regions that are collected by the image collector, to acquire quantities of users in front of each of the interaction regions; under the condition that a sum of the quantities of the users in front of each of the interaction regions is equal to 1, setting the touch-controlled screen to be in the single-person interaction mode; and under the condition that a sum of the quantities of the users in front of each of the interaction regions is greater than 1, setting the touch-controlled screen to be in the multi-person interaction mode.

By using such an implementation, the controller can realize self-adaptively setting the interaction mode of the touch-controlled screen according to the quantity of the users in front of the touch-controlled screen, which can further improve the interaction experience of the user.

In some alternative implementations of an embodiment of the present disclosure, the identifier comprises a graphic identifier and/or a text mark.

By using such an implementation, the interaction experience of the user can be further improved based on a high-interactivity graphic identifier and/or a clear text mark, which further facilitates to attract the attention of users, and can further improve the effect of the promotion of products or service.

In some alternative implementations of an embodiment of the present disclosure, the frame comprises a plurality of identifiers that can revolve around a predetermined center point in orbits that have different distances to the predetermined center point, and the controller is further configured for: changing the sizes of the identifiers and/or the orbits of their movements with the frequencies of the touch-controlling operations to the identifiers.

By using such an implementation, the interaction experience of the user can be further improved by using an exhibition mode that simulates the solar system or a similar galaxy in which planets revolve around a sun, which further facilitates to attract the attention of users, and can further improve the effect of the promotion of products or service. Furthermore, the sizes of the identifiers and/or the orbits of the movements of the identifiers may be self-adaptively set according to the attention levels of users, and the identifiers of high attention levels may be specifically highlighted.

In some alternative implementations of an embodiment of the present disclosure, the controller is further configured for: increasing the sizes of the identifiers with increasing of the frequencies of the touch-controlling operations to the corresponding identifiers; and/or, increasing the radiuses of the orbits of the movements of the identifiers with increasing of the frequencies of the touch-controlling operations to the corresponding identifiers. The exemplary embodiments have been described above, and are not discussed here further.

By using such an implementation, the present embodiment can, according to the attention levels of users, increase the size of the identifier of a high attention level and/or increase the radius of the orbit of the movement of the identifier of a high attention level, to specifically highlight the identifiers of high attention levels.

In some alternative implementations of an embodiment of the present disclosure, the exhibited information of the identifier comprises at least one of text information, image information and a sub-identifier of the identifier.

By using such an implementation, the present embodiment can enable the information exhibition to be more diversified, to improve the richness of the information, which can further improve the interaction experience of the user.

In some alternative implementations of an embodiment of the present disclosure, the controller is further configured for: in the multi-person interaction mode, in response to a touch-controlling operation in different interaction regions to an identifier that has moved to the interaction region, presenting a plurality of exhibition pages comprising text information and/or image information in the form of a buoyed layer on the corresponding interaction region, and in response to a sliding touch-controlling operation in the corresponding interaction region, displaying one exhibition page on top and in center.

By using such an implementation, the present embodiment can dynamically exhibit rich information to the users by using the corresponding interaction regions in the multi-person interaction mode, which can further improve the interaction experience of the user.

In some alternative implementations of an embodiment of the present disclosure, the controller is further configured for: in the single-person interaction mode,

in response to a touch-controlling operation in one interaction region to an identifier that has moved to the interaction region, presenting a sub-identifier list corresponding to the identifier in a sub-identifier displaying region of the touch-controlled screen and presenting, in an information displaying region of the touch-controlled screen, text information and/or image information of a sub-identifier of the sub-identifier list that is currently in a center position, and in response to a sliding touch-controlling operation to the sub-identifier list or a clicking touch-controlling operation to one sub-identifier, changing the sub-identifier of the sub-identifier list that is in the center position; or

in response to a touch-controlling operation in one interaction region to an identifier that has moved to the interaction region, presenting a sub-identifier list corresponding to the identifier in a sub-identifier displaying region of the touch-controlled screen, in response to a sliding touch-controlling operation to the sub-identifier list, changing the sub-identifier of the sub-identifier list that is in the center position, and in response to a clicking touch-controlling operation to the sub-identifier in the center position, presenting an exhibition page that comprises text information and/or image information in a form of a buoyed layer of the sub-identifier.

By using such an implementation, the present embodiment can dynamically exhibit rich information to the user in the single-person interaction mode, which can further improve the interaction experience of the user.

In some alternative implementations of an embodiment of the present disclosure, the controller is further configured for: in the single-person interaction mode, presenting in a navigation displaying region of the touch-controlled screen a navigation bar comprising the other identifiers and/or a returning identifier.

By using such an implementation, when the user is viewing the exhibited information of a certain identifier in the single-person interaction mode, he can directly, by a touch-controlling operation (for example, clicking) to the other identifiers and/or the returning identifier in the navigation bar, cause the touch-controlled screen to present in full screen the exhibited information of the other identifiers (i.e., skipping among the pieces of exhibited information of the identifiers) and/or stop presenting the exhibited information of the identifiers on the touch-controlled screen (i.e., causing the touch-controlled screen to return to the state of displaying the frame comprising a plurality of identifiers that can periodically move among the plurality of interaction regions), which can further improve the interaction experience of the user.

In some alternative implementations of an embodiment of the present disclosure, the controller is further configured for: under the condition that the exhibited information of the identifier is being presented on the corresponding interaction region or presented on the touch-controlled screen in full screen, judging whether the duration of no touch-controlling operation in the corresponding interaction region or the full screen of the touch-controlled screen is greater than a preset threshold, and if yes, stopping presenting the exhibited information of the identifier.

By using such an implementation, the present embodiment can, by using the preset duration threshold of no touch-controlling operation, enable the interaction region in the multi-person interaction mode or the full screen of the touch-controlled screen in the single-person interaction mode to automatically stop presenting the exhibited information of the identifier (i.e., causing the parts corresponding to the interaction regions or the touch-controlled screen as a whole to return to the state of displaying the frame comprising a plurality of identifiers that can periodically move among the plurality of interaction regions), which can further improve the interaction experience of the user.

In some alternative implementations of an embodiment of the present disclosure, the touch-controlled screen has three interaction regions that are arranged side by side.

In some alternative implementations of the present embodiment, the touch-controlled screen is a touch-controlled spliced screen that is formed by splicing a plurality of sub-touch-controlled screens, and each of the interaction regions corresponds to at least one of the sub-touch-controlled screens.

By using such an implementation, the present embodiment facilitates to realize a touch-controlled screen of a large size, which can further improve the interaction experience of the user, and is particularly suitable for simultaneous interaction of multiple users in the multi-person interaction mode.

In a particular embodiment, the controller comprises modules for controlling the touch-controlled screen to display the identifiers, the information and the interfaces in the single-person interaction mode or the multi-person interaction mode, for example, a plurality of functional modules corresponding to a plurality of identifiers and a static exhibition module corresponding to static information.

It should be noted that the principle and the working process of the device of displaying and interaction of information according to the present embodiment are similar to those of the method of displaying and interaction of information stated above, and the relative parts may refer to the above description, and are not discussed here further.

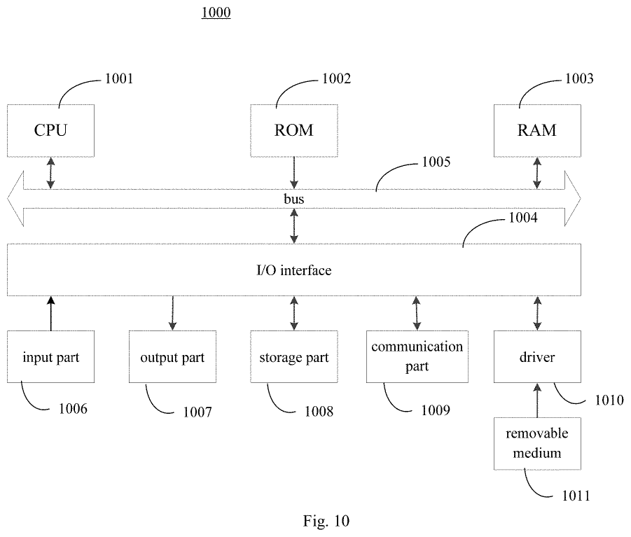

As shown in FIG. 10, a computer system 1000 adapted for implementing the device of displaying and interaction of information according to the present embodiment comprises a central processing module (CPU) 1001, which can, according to a program stored in a read-only memory (ROM) 1002 or a program loaded from a storage part to a random access memory (RAM) 1003, perform various proper actions and processes. The RAM further stores various programs and data that are required by the operation of the computer system. The CPU, the ROM and the RAM are interconnected by a bus. An input/output (I/O) interface 1004 is also connected to the bus 1005.

The following components are connected to the I/O interface: an input part 1006, including a keyboard, a mouse and so on; an output part 1007, including a liquid-crystal display (LCD), a loudspeaker and so on; a storage part 1008, including a hard disk and so on; and a communication part 1009, including for example a LAN card and a network interface card of a modem and so on. The communication part performs communication processing via a network such as Internet. A driver 1010 is also connected to the I/O interface according to demands. A removable medium 1011, such as a magnetic disk, an optical disc, a magneto-optical disk, a semiconductor memory and so on, is installed on the driver according to demands, so as to install the computer program read therefrom into the storage part according to demands.

Particularly, according to the present embodiment, the process illustrated in the above flow chart may be realized as a computer software program. For example, the present embodiment comprises a computer program product, which comprises a computer program tangibly contained in a computer-readable medium, and the computer program comprises a program code for implementing method shown in the flow chart. In such an embodiment, the computer program may be downloaded and installed from a network by using the communication part, and/or be installed from the removable medium.

The flow charts and the schematic diagrams of the drawings illustrate the system architectures, functions and operations that can be realized by the system, the method and the computer program product according to the present embodiment. In this regard, each of the blocks in the flow charts or the schematic diagrams may represent part of a module, a program segment or a code, and the part of the module, the program segment or the code contains one or more executable instructions for performing specified logic functions. Further, it should be noted that, in some alternative implementations, the functions marked in the blocks may also be performed in a sequence that is different from that marked in the drawings. For example, two blocks illustrated in succession may actually be executed substantially concurrently, and they sometimes may also be executed in an opposite sequence, which depends on the involved functions. Furthermore, it should be noted that each of the blocks in the schematic diagrams and/or the flow charts, and a combination of the blocks in the schematic diagrams and/or the flow charts, may be implemented by using a dedicated hardware-based system for performing specified functions or operations, or may be implemented by using a combination of a dedicated hardware and a computer instruction.

As another aspect, the present embodiment further provides a nonvolatile computer storage medium. The nonvolatile computer storage medium may be a nonvolatile computer storage medium that is contained in the device according to the above embodiments, and may also be a nonvolatile computer storage medium that stands alone and has not been installed into a terminal. The nonvolatile computer storage medium stores one or more programs, and the one or more programs, when executed by a device, cause the device to perform the operations of: displaying a frame on a touch-controlled screen having a plurality of interaction regions, wherein the frame comprises a plurality of identifiers that can periodically move among the plurality of interaction regions; and in response to a touch-controlling operation in different interaction regions to an identifier that has moved to the interaction region, presenting the exhibited information of the identifier on the corresponding interaction region.

It should be noted that, in the description of the present disclosure, relation terms such as first and second are merely intended to distinguish one entity or operation from another entity or operation, and that does not necessarily require or imply that those entities or operations have therebetween any such actual relation or order. Furthermore, the terms “include”, “comprise” or any variants thereof are intended to cover non-exclusive inclusions, so that processes, methods, articles or devices that include a series of elements do not only include those elements, but also include other elements that are not explicitly listed, or include the elements that are inherent to such processes, methods, articles or devices. Unless further limitation is set forth, an element defined by the wording “comprising a . . . ” does not exclude additional same element in the process, method, article or device comprising the element.

Apparently, the above embodiments of the present disclosure are merely examples that are made for clearly describing the present disclosure, and are not limitation on the embodiments of the present disclosure, and a person skilled in the art can make other variations or modifications in different forms on the basis of the above description. The embodiments cannot be exhaustively listed herein, and all of the obvious variations or modifications that are made on the basis of the technical solutions of the present disclosure still fall within the protection scope of the present disclosure.

1. A method of displaying and interaction of information, comprising:
displaying a frame on a touch-controlled screen having a plurality of interaction regions, wherein the frame comprises a plurality of identifiers, a displaying position of each identifier of the plurality of identifiers on the touch-controlled screen changes over time, to form a displaying trajectory of the identifier, and the displaying trajectory of the identifier is distributed in the plurality of interaction regions; and
under the condition that the displaying position of the identifier has entered any one interaction region of the plurality of interaction regions, in response to a touch-controlling operation to the identifier, presenting exhibited information of the any one identifier on the touch-controlled screen.

2. The method according to claim 1, wherein before the step of, in response to the touch-controlling operation to the identifier, presenting the exhibited information of the any one identifier on the touch-controlled screen, the method further comprises:
detecting whether an interaction mode of the touch-controlled screen is a single-person interaction mode or a multi-person interaction mode; and
the step of, in response to the touch-controlling operation to the identifier, presenting the exhibited information of the any one identifier on the touch-controlled screen comprises:
under the condition that it is detected that the interaction mode of the touch-controlled screen is the single-person interaction mode, in response to a touch-controlling operation to the identifier in the any one interaction region, presenting the exhibited information of the identifier on the touch-controlled screen in full screen; and
under the condition that it is detected that the interaction mode of the touch-controlled screen is the multi-person interaction mode, in response to a touch-controlling operation to the identifier in the any one interaction region, presenting the exhibited information of the identifier on the any one interaction region.

3. The method according to claim 2, wherein the step of detecting whether the interaction mode of the touch-controlled screen is a single-person interaction mode or a multi-person interaction mode comprises:
collecting scene images in front of the interaction regions and performing image recognition, to acquire quantities of users in front of each of the interaction regions;
under the condition that a sum of the quantities of the users in front of each of the interaction regions is equal to 1, determining that the interaction mode of the touch-controlled screen is the single-person interaction mode; and
under the condition that a sum of the quantities of the users in front of each of the interaction regions is greater than 1, determining that the interaction mode of the touch-controlled screen is the multi-person interaction mode.

4. The method according to claim 1, wherein the identifier comprises a graphic identifier and/or a text mark.

5. The method according to claim 4, wherein the respective displaying trajectories of the plurality of identifiers are a plurality of orbit trajectories that revolve around a predetermined center point; and
a size of each identifier of the plurality of identifiers changes with a frequency of touch-controlling operations to the identifier.

6. The method according to claim 4, wherein the respective displaying trajectories of the plurality of identifiers are a plurality of orbit trajectories that revolve around a predetermined center point; and
a size of the displaying trajectory of each identifier of the plurality of identifiers changes with a frequency of touch-controlling operations to the identifier.

7. The method according to claim 5, wherein
the changing of the size of the identifier with the frequency of the touch-controlling operations to the identifier comprises: increasing the size of the identifier with increasing of the frequency of the touch-controlling operations to the identifier; or
the changing of the size of the displaying trajectory of the identifier with the frequency of the touch-controlling operations to the identifier comprises: increasing a radius of the displaying trajectory of the identifier with increasing of the frequency of the touch-controlling operations to the identifier.

8. The method according to claim 2, wherein the exhibited information of the identifier comprises: at least one of text information, image information and a sub-identifier of the identifier.

9. The method according to claim 8, wherein the step of, in response to the touch-controlling operation to the identifier in the any one interaction region, presenting the exhibited information of the identifier on the any one interaction region comprises:
in response to the touch-controlling operation to the identifier in the any one interaction region, presenting a plurality of exhibition pages on the any one interaction region, wherein each of the plurality of exhibition pages comprises text information and/or image information in a form of a buoyed layer; and
in response to a sliding touch-controlling operation in the any one interaction region, displaying one exhibition page of the plurality of exhibition pages on top and in center.

10. The method according to claim 8, wherein the step of, in response to the touch-controlling operation to the identifier in the any one interaction region, presenting the exhibited information of the identifier on the touch-controlled screen in full screen comprises:
in response to the touch-controlling operation to the identifier in the any one interaction region, presenting a sub-identifier list of the identifier in a sub-identifier displaying region of the touch-controlled screen, and presenting, in an information displaying region of the touch-controlled screen, text information and/or image information of a sub-identifier of the sub-identifier list that is currently in a center position, and in response to a sliding touch-controlling operation to the sub-identifier list or a clicking touch-controlling operation to one sub-identifier of the sub-identifier list, changing the sub-identifier of the sub-identifier list that is in the center position; or
in response to the touch-controlling operation to the identifier in the any one interaction region, presenting a sub-identifier list corresponding to the identifier in a sub-identifier displaying region of the touch-controlled screen, in response to a sliding touch-controlling operation to the sub-identifier list, changing the sub-identifier of the sub-identifier list that is in the center position, and in response to a clicking touch-controlling operation to the sub-identifier in the center position, presenting an exhibition page that comprises text information and/or image information in a form of a buoyed layer of the sub-identifier.

11. The method according to claim 10, wherein the step of, in response to the touch-controlling operation to the identifier in the any one interaction region, presenting the exhibited information of the identifier on the touch-controlled screen in full screen further comprises:
presenting a navigation bar in a navigation displaying region of the touch-controlled screen, wherein the navigation bar comprises at least one of: the other identifiers of the plurality of identifiers, and a returning identifier.

12. The method according to claim 2, further comprising:
under the condition that the exhibited information of the identifier is being presented on the any one interaction region or presented on the touch-controlled screen in full screen, judging whether a touch-controlling operation to the exhibited information is received within a preset duration threshold, and if no, stopping presenting the exhibited information of the identifier.

13. A device of displaying and interaction of information, wherein the device comprises a controller and a touch-controlled screen;
the touch-controlled screen has a plurality of interaction regions; and
the controller is configured for implementing the method according to claim 1.

14. The device according to claim 13, wherein the touch-controlled screen has three interaction regions that are arranged side by side.

15. The device according to claim 13, wherein the touch-controlled screen is a touch-controlled spliced screen that is formed by splicing a plurality of sub-touch-controlled screens, and each of the interaction regions comprises at least one of the sub-touch-controlled screens.

16. A computer device, comprising a memory, a processor and a computer program that is stored in the memory and is executable on the processor, wherein the processor, when executing the computer program, implements the method according to claim 1.

17. A computer-readable storage medium, storing a computer program, wherein the computer program, when being executed by a processor, implements the method according to claim 1.

18. The computer device according to claim 16, wherein before the step of, in response to the touch-controlling operation to the identifier, presenting the exhibited information of the any one identifier on the touch-controlled screen, the method further comprises:
detecting whether an interaction mode of the touch-controlled screen is a single-person interaction mode or a multi-person interaction mode; and
the step of, in response to the touch-controlling operation to the identifier, presenting the exhibited information of the any one identifier on the touch-controlled screen comprises:
under the condition that it is detected that the interaction mode of the touch-controlled screen is the single-person interaction mode, in response to a touch-controlling operation to the identifier in the any one interaction region, presenting the exhibited information of the identifier on the touch-controlled screen in full screen; and
under the condition that it is detected that the interaction mode of the touch-controlled screen is the multi-person interaction mode, in response to a touch-controlling operation to the identifier in the any one interaction region, presenting the exhibited information of the identifier on the any one interaction region.

19. The computer device according to claim 18, wherein the step of detecting whether the interaction mode of the touch-controlled screen is a single-person interaction mode or a multi-person interaction mode comprises:
collecting scene images in front of the interaction regions and performing image recognition, to acquire quantities of users in front of each of the interaction regions;
under the condition that a sum of the quantities of the users in front of each of the interaction regions is equal to 1, determining that the interaction mode of the touch-controlled screen is the single-person interaction mode; and
under the condition that a sum of the quantities of the users in front of each of the interaction regions is greater than 1, determining that the interaction mode of the touch-controlled screen is the multi-person interaction mode.

20. The computer-readable storage medium according to claim 17, wherein before the step of, in response to the touch-controlling operation to the identifier, presenting the exhibited information of the any one identifier on the touch-controlled screen, the method further comprises:
detecting whether an interaction mode of the touch-controlled screen is a single-person interaction mode or a multi-person interaction mode; and
the step of, in response to the touch-controlling operation to the identifier, presenting the exhibited information of the any one identifier on the touch-controlled screen comprises:
under the condition that it is detected that the interaction mode of the touch-controlled screen is the single-person interaction mode, in response to a touch-controlling operation to the identifier in the any one interaction region, presenting the exhibited information of the identifier on the touch-controlled screen in full screen; and
under the condition that it is detected that the interaction mode of the touch-controlled screen is the multi-person interaction mode, in response to a touch-controlling operation to the identifier in the any one interaction region, presenting the exhibited information of the identifier on the any one interaction region.
